(19) United States
(12) Patent Application Publication
(10) Pub. No.: US 2026/0173216 A1
(43) Pub. Date: Jun. 18, 2026

(54) RAIL SWITCH HEATING PEAK CURRENT MITIGATION

(71) Applicant: Backer EHP Inc., Murfreesboro, TN (US)

(72) Inventor: Kevin M. Clyne, Asheville, NC (US)

(21) Appl. No.: 18/979,137

(22) Filed: Dec. 12, 2024

(51) Int. Cl. H05B 3/00; E01B 7/24; H05B 1/02

(52) U.S. Cl. CPC H05B 3/0019; E01B 7/24; H05B 1/0233; H05B 2203/005; H05B 2214/02

(57) ABSTRACT

Various electricity reduction and peak current mitigation apparatus and methods therefor for railroads are disclosed. In one embodiment, an electricity reduction apparatus includes a plurality of electrically resistive rail heating elements and at least one controller configured to couple an electric current measured by an electric utility meter to the plurality of electrically resistive rail heating elements. The at least one controller comprises a plurality of channels arranged in at least first and second banks, and each of the channels of the at least first and second banks are connected to respective electrically resistive rail heating elements. The at least one controller is configured to repeatedly cycle the electric current on and off to the at least first and second banks of channels. The electric current is cycled on to the first bank of channels when the electric current is cycled off to the second bank of channels and vice-versa.

### BACKGROUND

The railroad industry, including passenger railroads, freight railroads, and other industry railroads, consume electrical energy from electrical grids to operate the railroad. Railroad consumers of electrical energy include trains, rail cars, rail switch elements, roadway gate closure systems, and rail heater systems, to name a few. Given the relatively large electricity demand of railroads and railroad-related systems, electric utility companies must be configured to reliably meet the electricity demand, which demand may vary depending (among other reasons) on the outside air temperature in the vicinity in which the railroad operates. However, a significant challenge exists for electric utility companies to predict peak electrical current demand for a given day and for a given location along the railroad. In addition, while electric utility companies are interested in reducing electricity demand via energy conservation methods, electric utility companies are more interested in being able to manage the electrical grid, and that is accomplished at least in part by being able to reliably forecast electricity demand. Unfortunately for electrical utility companies engaged in electrically powering railroads, that goal has been elusive to achieve in practice.

There exists a need, therefore, for a solution that addresses these and other problems.

### SUMMARY

Disclosed herein are various embodiments of a rail switch heating peak current mitigation system to reduce peak electricity demand and total electricity consumption by railroads when heating railroad rails in cold weather. In one embodiment, an electricity reduction apparatus for railroads comprises: (a) a plurality of electrically resistive heating elements configured for mounting on at least one railroad rail, the plurality of electrically resistive heating elements comprising first, second, third, and fourth electrically resistive heating elements; and (ii) a controller configured to couple an electric current measured by an electric utility meter to the plurality of electrically resistive heating elements, the controller comprising a processor, memory, first and second high voltage channels arranged in a first bank and third and fourth high voltage channels arranged in a second bank, the first and second high voltage channels configured to connect the electric current to the first and second electrically resistive heating elements, respectively, via respective first and second junctions, the third and fourth high voltage channels configured to connect the electric current to the third and fourth electrically resistive heating elements, respectively, via respective third and fourth junctions. The controller is configured to repeatedly cycle the electric current on and off to the first and second banks of channels, wherein the electric current is cycled on to the first bank of channels when the electric current is cycled off to the second bank of channels and vice-versa.

The duration of the on cycle may be equal to a duration of the off cycle. Alternatively, the duration of the on cycle may be different than a duration of the off cycle. The electricity reduction apparatus may include a plurality of the controllers, where each of the controllers are configured to couple the electric current measured by the electric utility meter to the plurality of electrically resistive heating elements. The electric current may be synchronously cycled on to the first bank of channels of each of the plurality of controllers when the electric current is cycled off to the second bank of channels of each of the plurality of controllers and vice-versa. Each of the plurality of controllers may be configured to be coupled to a synchronizing system, such as a GPS clock, across all controllers serviced by said electric meter, to synchronously cycle on and off the first and second banks of channels of each of the plurality of controllers. The electricity reduction apparatus may include a contactor associated with each of the channels to turn on and off the electric current to each of the channels.

In another embodiment, a method for reducing electricity consumption by railroads is disclosed, comprising (i) providing a plurality of electrically resistive heating elements configured for mounting on at least one railroad rail, the plurality of electrically resistive heating elements comprising first, second, third, and fourth electrically resistive heating elements; (ii) providing a controller comprising a processor, memory, first and second high voltage channels arranged in a first bank and third and fourth high voltage channels arranged in a second bank, the first and second high voltage channels configured to connect an electric current to the first and second electrically resistive heating elements, respectively, via respective first and second junctions, the third and fourth high voltage channels configured to connect the electric current to the third and fourth electrically resistive heating elements, respectively, via respective third and fourth junctions; and (iii) repeatedly cycling, by the controller, the electric current on and off to the first and second banks of channels by cycling the electric current on to the first bank of channels when the electric current is cycled off to the second bank of channels and vice-versa.

The step of cycling the electric current on may span a duration that is equal to a duration of cycling the electric current off. Alternatively, the step of cycling the electric current on may span a duration that is different than a duration of cycling the electric current off. The step of providing a controller may include providing a plurality of the controllers, each of the controllers configured to couple the electric current measured by the electric utility meter to the plurality of electrically resistive heating elements. The method for reducing electricity consumption may include synchronously cycling the electric current on to the first bank of channels of each of the plurality of controllers when synchronously cycling the electric current off to the second bank of channels of each of the plurality of controllers and vice-versa. The method for reducing electricity consumption may include coupling each of the plurality of controllers to a timing system comprising a GPS clock for synchronously cycling on and off the first and second banks of channels of each of the plurality of controllers. The method for reducing electricity consumption may include providing a contactor associated with each of the channels to turn on and off the electric current to each of the channels.

In another embodiment, a non-transitory computer readable medium is disclosed comprising instructions, which, when executed, cause a machine to (i) provide electric current to first and second high voltage channels arranged in a first bank and to third and fourth high voltage channels arranged in a second bank, the first and second high voltage channels configured to connect the electric current to respective first and second electrically resistive heating elements configured to be disposed on respective first and second railroad rails, the third and fourth high voltage channels configured to connect the electric current to respective third and fourth electrically resistive heating elements configured to be disposed on respective third and fourth railroad rails; and (ii) repeatedly cycle the electric current on and off to the first and second banks of channels. The electric current is cycled on to the first bank of channels when the electric current is cycled off to the second bank of channels and vice-versa.

### BRIEF DESCRIPTION OF THE DRAWINGS

FIG. 1 is a schematic view of one embodiment of rail switch heating peak current mitigation system of the instant disclosure.

FIG. 2 is a schematic view of a notional scenario absent implementation of the teachings of the instant disclosure.

FIG. 3 is schematic view of the scenario of FIG. 2 showing the results of applying the teachings of the instant disclosure thereto.

### DETAILED DESCRIPTION

Although the figures and the instant disclosure describe one or more embodiments of a rail switch heating peak current mitigation system, one of ordinary skill in the art would appreciate that the teachings of the instant disclosure would not be limited to these embodiments. It should be appreciated that any of the features of an embodiment discussed with reference to the figures herein may be combined with or substituted for features discussed in connection with other embodiments in this disclosure.

Various embodiments of a rail switch heating peak current mitigation system are disclosed herein to help electric utility companies predict and manage peak electrical current demand and electrical consumption from railroads and railroad operators. In various embodiments, rail switch heating peak current mitigation systems of the instant disclosure include one or more controllers configured to connect utility electric current with one or more rail heating elements and related systems. The one or more controllers may be housed in separate enclosures or in one enclosure, and the enclosure(s) may be positioned in proximity to the railroad electricity consumers and components described in the instant disclosure. As set forth below, the one or more controllers may comprise part of a bank switching apparatus to control the on/off status of the one or more rail heating elements and related systems. In various embodiments, each of the one or more controllers comprise components that are connected to utility electric current via a common utility electric meter and a synchronizing system, such as a GPS clock, to synchronize operation of each of the one or more controllers and each of the one or more rail heating elements and related systems.

The one or more controllers may include low voltage components and high voltage components. The low voltage components may include (i) one or more microprocessors, (ii) one or more software algorithms stored on memory and executable by the one or more microprocessors to control the operation of one or more components of the controller or one or more downstream components connected thereto, (iii) a communications bus and related communications equipment for communicating information to and from other devices and systems via any type of wired or wireless methods, including, for example, cellular, satellite, Bluetooth, and Wi-Fi, using any form of wired or wireless communications protocol and across any network, (iv) sensors, (v) battery and battery driven components, and (vi) other low voltage components applicable for use in connection with operation of a railroad.

The high voltage components may include one or more high voltage relays, contactors, and electrical current sensors. The high voltage components may be electrically powered banks of two or more electrically powered channels, each of which may be connected to one or more electrically powered rail heating elements and/or systems that are connected to a rail system turnout to prevent or mitigate rail switch freezing when the rail heating elements are electrically energized with electric current. “High voltage” in this context is utility line voltage supplied to railroads and railroad operators (e.g., 110V and higher), and “low voltage” is any voltage less than line voltage (e.g., 24V and lower).

Examples of various rail heating elements, related heating systems, and related methods for heating the rail components via various arrangements of rail heating elements are described in U.S. Pat. No. 11,725,347, the contents of which is incorporated by reference herein. A target wattage of the various rail heating elements described in U.S. Pat. No. 11,725,347 may be achieved by averaging a pulsed duty cycle of power—PWM. That can be achieved by turning one or more rail heating elements on and off in fixed or varying duty cycles and at a predetermined modulation (frequency of the transition from on to off and from off to on). For example, a 250 watt per foot heating element that is driven by a 480 VAC supply could achieve a 125 watt effective wattage per foot by using a duty cycle of 50% over a modulated frequency. Similarly, a pair of 250 watt per foot heating elements may be driven at 100% duty cycle to provide 500 watts per foot when needed for extreme weather conditions.

The instant disclosure solves a different problem by describing a different approach to turning on and off the one or more rail heating elements. In various embodiments, each of the channels of the banks of two more electrically powered channels may each be configured to route electric current to a respective rail system turnout comprising, for example, the rail heating elements and systems described in U.S. Pat. No. 11,725,347. In various embodiments, the controller may command a bank comprising a pair of channels to deliver electric current to turn “on” the one or more rail heating elements of the respective rail system turnouts. In similar fashion, the controller may command another bank comprising a pair of channels to cease delivering electric current to turn “off” the one or more rail heating elements of the respective rail system turnouts that are connected to those respective channels. The electric loads associated with each of the two channels in the first bank may vary with respect to one another over time. Likewise, the electric loads associated with each of the two channels in the second bank may vary with respect to one another over time. Similarly, the electric loads associated with each of the two channels in the first bank and each of the two channels in the second bank may vary with respect to one another over time. By alternating the delivery of electric current from the two banks over a predetermined period of time, such as 5 minutes, 10 minutes, or any selected duration, a pulse width modulated (PWM) duty cycle is achieved for each of the banks of channels. The practical result is that the bank power switching apparatus of the instant disclosure reduces both the peak electric current draw and the total current consumption from all loads because, in this embodiment, the rail heating elements of at most only two rail system turnouts may be energized at a given time instead of potentially all of the rail heating elements for all four rail system turnouts. As set forth in this disclosure, each of the banks could control a greater number, or a fewer number, of channels than two channels. Likewise, more than one controller can be connected to the common utility electric meter and to a synchronizing system, such as a GPS clock, to synchronize operation of two or more controllers.

The bank power switching apparatus of the instant disclosure works counterintuitively because turning off electric current to an electrically resistive heating element conjures images of reducing the temperature of the object to be heated when the heating element is cycled off. But that is not the case here because railroad rails, once heated, tend to act as heat sinks. In addition, in various embodiments the on/off cycle durations can be automatically adjusted longer or shorter on the fly by the controller to best match the current and predicted outside air temperature and the ability of the steel railroad rails to retain heat at that current and/or predicted air temperature.

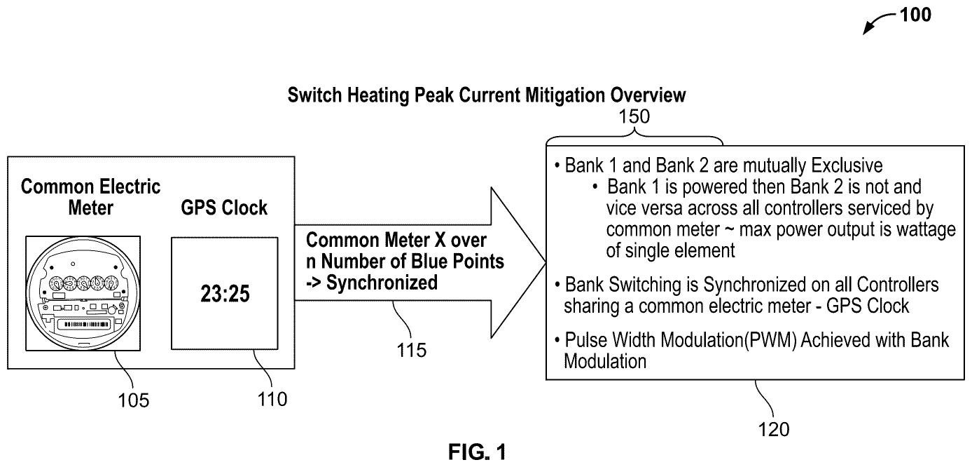

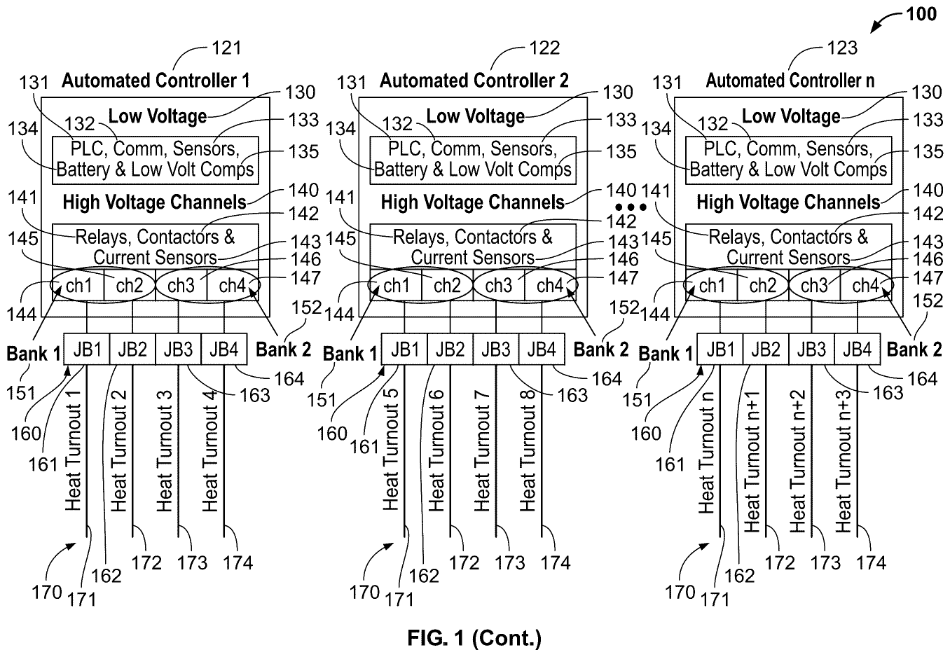

Turning now to the drawings and to FIGS. 1-3 in particular, there are shown various aspects of a representative rail switch heating peak current mitigation system 100 of the instant disclosure. As illustrated in the figures, representative rail switch heating peak current mitigation system 100 includes one or more electrical connections 115 between one or more controllers 120 and electric utility meter 105 and a synchronizing device or system, such as a GPS clock 110. The one or more controllers 120 are connected to one or more junctions 160 comprising one or more isolation circuit breakers (not shown) for communicating high voltage electricity to one or more rail system turnouts 170. The one or more controllers 120 include one or more low voltage components 130 and one or more high voltage components 140.

In the embodiment shown in the figures, the one or more low voltage components 130 include one or more microprocessors 131, one or more software algorithms stored on memory (not shown) and executable by the one or more microprocessors to control the operation of one or more components of the controller or one or more downstream components connected thereto, (iii) a communications system 132 comprising a communications bus and related communications equipment for communicating information to and from other devices and systems via any type of wired or wireless methods, including, for example, cellular, satellite, Bluetooth, and Wi-Fi, using any form of wired or wireless communications protocol and across any network, (iv) one or more sensors 133, (v) battery 134 and battery driven components, and (vi) other low voltage components 135 applicable for use in connection with operation of a railroad.

In the embodiment shown in the figures, the one or more high voltage components 140 include one or more relays 141, one or more contactors 142, and one or more current sensors 143. The one or more high voltage components 140 include one or more high voltage channels 144,145,146,147 that are operationally arranged or bundled into one or more banks 150. In this embodiment, the one or more banks 150 include banks 151,152, each configured to operate a pair of high voltage channels 144,145 and 146,147, respectively. Each of the high voltage channels 144,145,146,147 are electrically connected to respective junctions 161,162,163,164, and each of the junctions 161,162,163,164 are electric connected to respective rail system turnouts 171,172,173,174 to electrically energize and de-energize one or more electrically powered rail heating elements and/or systems (not shown). In other embodiments, banks 151,152 may each be configured to include more than two high voltage channels. Likewise, in other embodiments, each N number of channels 144,145,146,147 . . . N may be connected to more than one of junction 160 corresponding to more than one of rail system turnout 170. Thus, the number of channels 140, banks 150, junctions 160, and rail system turnouts 170 may vary. In addition, in various embodiments, the one or more rail heating elements and/or systems may be positioned on the same railroad rail as other one or more rail heating elements and/or systems, all corresponding to a single rail system turnout 170. In other embodiments, the one or more rail heating elements and/or systems may be positioned in different rail system turnouts 170. One of ordinary skill would appreciate that the one or more rail heating elements and/or systems may be described simply as one or more loads.

In the embodiment shown in the figures, an N number of controllers 121,122,123, . . . N are connected to the same electric utility meter 105 and a synchronizing device or system comprising, for example, a GPS clock 110, to enable synchronized operation of the N number of controllers 121,122,123, . . . N and synchronized on/off operation of one or more rail heating elements and/or systems (not shown) associated with an N number of rail system turnouts 171,172,173,174, . . . N.

During operation of rail switch heating peak current mitigation system 100 shown in the figures, upon receiving a call for heat to be delivered to at least one of rail system turnouts 171,172,173, or 174, each of N number of controllers 121,122,123, . . . N may automatically connect high voltage channels 144,145 of bank 151 or high voltage channels 146,147 of bank 152 to high voltage supplied by the electric utility via one or more relays 141 and the one or more contactors 142. The selected bank 151 or bank 152 to energize the connected rail heating elements and/or systems may be predetermined by the algorithm that operates each of N number of controllers 121,122,123, . . . N. If channels 144,145 of bank 151 are energized first, for example, the connected one or more rail heating elements and/or systems of rail system turnouts 171,172, via respective junctions 161,162, may draw electrical current to turn “on” the one or more rail heating elements for a predetermined duration of time.

Upon reaching the predetermined duration of time, the N number of controllers 121,122,123, . . . N may automatically cause the electricity to cease flowing through the channels 144,145 of bank 151, thereby causing the connected rail heating elements and/or systems to turn “off” and to cease delivery of heat energy to the rail(s). In its place, the N number of controllers 121,122,123, . . . N may automatically initiate the flow of electricity to the channels of bank 152, thereby causing the flow of electricity to rail system turnouts 173,174 to energize the rail heating elements and/or systems connected thereto. The N number of controllers 121,122,123, . . . N may automatically continue the on/off cycles until the call for heat no longer exists.

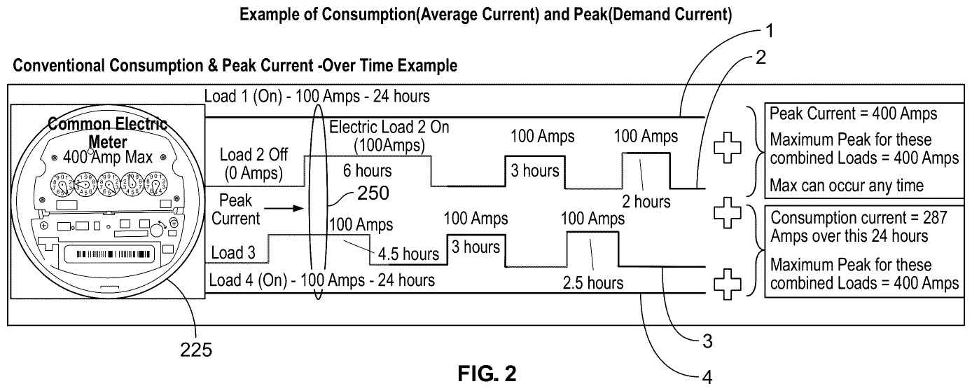

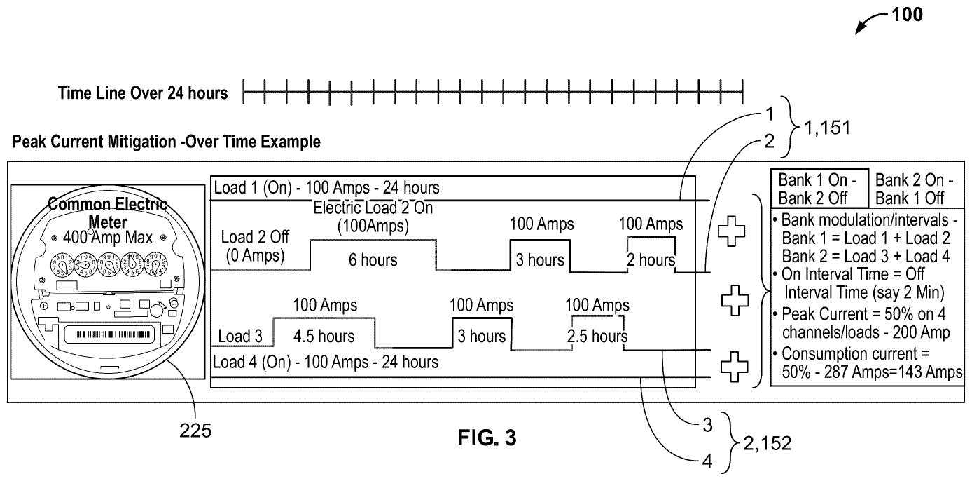

Turning to FIG. 2-3 there are shown a representative schematic examples of electrical energy consumption and peak current drawn over time, with and without deployment of the rail switch heating peak current mitigation system 100 of the instant disclosure. FIG. 2, for example, shows a representative model of four exemplary electric loads 1,2,3,4 connected to a common electric utility meter 225 over a notional 24-hour period. Loads 1 and 4 are shown as drawing a constant 100 amps for the entire 24-hour period. Load 2 is shown as drawing zero amps for a first block of time, then 100 amps for 6 hours, then zero amps for another block of time, then 100 amps for 3 hours, then zero amps for 2.5 hours, then 100 amps for 2 hours. Load 3 is shown as drawing zero amps for a first block of time, then 100 amps for 4.5 hours, then zero amps for another block of time, then 100 amps for 3 hours, then zero amps for 3 hours, then zero amps for another block of time. The total number of amps consumed by all four loads during this notional 24-hour period is 287 amps, and at point 250 along the 24-hour timeline, the peak current drawn is 400 amps.

FIG. 3 shows the result of implementing the teachings of the instant disclosure, most notably, a 50% reduction in the total current consumption over a notional 24-hour period, and a 50% reduction in the peak current consumed at any point during the same 24-hour period, all the foregoing assuming the same load profiles. That result is accomplished by bundling the operation of loads 1 and 2 (corresponding to channels 1 and 2) with bank 1 (i.e., bank 151) of controller 120, and bundling loads 3 and 4 (corresponding to channels 3 and 4) with bank 2 (i.e., bank 152) of controller 120. In this example, the “on” duration for any bank is 2 minutes, and the “off” duration for any bank is 2 minutes. In addition, each of the loads 1,2,3,4 correspond to individual rail heating elements and related systems

In this example, because controller 120 is configured to turn “on” bank 1 (i.e., bank 151) comprising loads 1,2 when bank 2 (i.e., bank 152) comprising loads 3,4 is “off” and vice-versa, the net effect is a reduction in the current draw and the peak current at every moment in time over the 24-hour period as compared to the example shown in FIG. 2. In other words, when loads 1 and 2 are drawing a total of 200 amps at certain times in the 24-hour period when bank 1 (i.e., bank 151) is turned “on,” that current draw occurs at the same time that loads 3 and 4 are turned “off” by controller 120 commanding bank 2 (i.e., bank 152) to turn “off” during the predetermined 2-minute on (for bank 1)/off (for bank 2) time duration. In this way, the pulse width modulated banks of channels lower the overall electricity consumption from the loads and reduce the peak current demand at any point in time.

While specific embodiments have been described in detail, it will be appreciated by those skilled in the art that various modifications and alternatives to those details could be developed in light of the overall teachings of the disclosure. Accordingly, the disclosure herein is meant to be illustrative only and not limiting as to its scope and should be given the full breadth of the appended claims and any equivalents thereof.

What is claimed is:

1. An electricity reduction apparatus for railroads, comprising:
a plurality of electrically resistive heating elements configured for mounting on at least one railroad rail, the plurality of electrically resistive heating elements comprising first, second, third, and fourth electrically resistive heating elements;
a controller configured to couple an electric current measured by an electric utility meter to the plurality of electrically resistive heating elements, the controller comprising a processor, memory, first and second high voltage channels arranged in a first bank and third and fourth high voltage channels arranged in a second bank, the first and second high voltage channels configured to connect the electric current to the first and second electrically resistive heating elements, respectively, via respective first and second junctions, the third and fourth high voltage channels configured to connect the electric current to the third and fourth electrically resistive heating elements, respectively, via respective third and fourth junctions, wherein the controller is configured to:
repeatedly cycle the electric current on and off to the first and second banks of channels, wherein the electric current is cycled on to the first bank of channels when the electric current is cycled off to the second bank of channels and vice-versa.

2. The electricity reduction apparatus for railroads of claim 1, wherein a duration of the on cycle is equal to a duration of the off cycle.

3. The electricity reduction apparatus for railroads of claim 1, wherein a duration of the on cycle is different than a duration of the off cycle.

4. The electricity reduction apparatus for railroads of claim 1, including a plurality of the controllers, each of the controllers configured to couple the electric current measured by the electric utility meter to the plurality of electrically resistive heating elements.

5. The electricity reduction apparatus for railroads of claim 4, wherein the electric current is synchronously cycled on to the first bank of channels of each of the plurality of controllers when the electric current is cycled off to the second bank of channels of each of the plurality of controllers and vice-versa.

6. The electricity reduction apparatus for railroads of claim 5, wherein each of the plurality of controllers are configured to be coupled to a synchronizing system to synchronously cycle on and off the first and second banks of channels of each of the plurality of controllers.

7. The electricity reduction apparatus for railroads of claim 6, wherein the synchronizing system comprises a GPS clock.

8. The electricity reduction apparatus for railroads of claim 1, including a contactor associated with each of the channels to turn on and off the electric current to each of the channels.

9. A method for reducing electricity consumption by railroads, comprising:
providing a plurality of electrically resistive heating elements configured for mounting on at least one railroad rail, the plurality of electrically resistive heating elements comprising first, second, third, and fourth electrically resistive heating elements;
providing a controller comprising a processor, memory, first and second high voltage channels arranged in a first bank and third and fourth high voltage channels arranged in a second bank, the first and second high voltage channels configured to connect an electric current to the first and second electrically resistive heating elements, respectively, via respective first and second junctions, the third and fourth high voltage channels configured to connect the electric current to the third and fourth electrically resistive heating elements, respectively, via respective third and fourth junctions;
repeatedly cycling, by the controller, the electric current on and off to the first and second banks of channels by cycling the electric current on to the first bank of channels when the electric current is cycled off to the second bank of channels and vice-versa.

10. The method for reducing electricity consumption of claim 9, wherein cycling the electric current on spans a duration that is equal to a duration of cycling the electric current off.

11. The method for reducing electricity consumption of claim 9, wherein cycling the electric current on spans a duration that is different than a duration of cycling the electric current off.

12. The method for reducing electricity consumption of claim 9, wherein providing a controller includes providing a plurality of the controllers, each of the controllers configured to couple the electric current measured by the electric utility meter to the plurality of electrically resistive heating elements.

13. The method for reducing electricity consumption of claim 12, including synchronously cycling the electric current on to the first bank of channels of each of the plurality of controllers when synchronously cycling the electric current off to the second bank of channels of each of the plurality of controllers and vice-versa.

14. The method for reducing electricity consumption of claim 13, including coupling each of the plurality of controllers to a timing system comprising a GPS clock for synchronously cycling on and off the first and second banks of channels of each of the plurality of controllers.

15. The method for reducing electricity consumption of claim 9, including providing a contactor associated with each of the channels to turn on and off the electric current to each of the channels.

16. A non-transitory computer readable medium comprising instructions, which, when executed, cause a machine to:
provide electric current to first and second high voltage channels arranged in a first bank and to third and fourth high voltage channels arranged in a second bank, the first and second high voltage channels configured to connect the electric current to respective first and second electrically resistive heating elements configured to be disposed on respective first and second railroad rails, the third and fourth high voltage channels configured to connect the electric current to respective third and fourth electrically resistive heating elements configured to be disposed on respective third and fourth railroad rails;
repeatedly cycle the electric current on and off to the first and second banks of channels, wherein the electric current is cycled on to the first bank of channels when the electric current is cycled off to the second bank of channels and vice-versa.
